(19) United States
(12) Patent Application Publication
(10) Pub. No.: US 2017/0030067 A1
(43) Pub. Date: Feb. 2, 2017

(54) BIDET INCLUDING NOZZLE ASSEMBLY

(71) Applicant: COWAY CO., LTD, Chungcheongnam-do (KR)

(72) Inventors: Sung-Worl JIN, Seoul (KR); Hee-Ju KANG, Seoul (KR); Kyu-Joo PARK, Seoul (KR); Young-Pyo KIM, Seoul (KR)

(21) Appl. No.: 15/303,037

(22) PCT Filed: Apr. 7, 2015
(86) PCT No.: PCT/KR2015/003467

§ 371 Date: Oct. 10, 2016

(30) Foreign Application Priority Data
Apr. 11, 2014 (KR) 10-2014-0043350

(51) Int. Cl. E03D 9/08; A61H 35/00

(52) U.S. Cl. CPC E03D 9/08; A61H 35/00; A47K 13/00

(57) ABSTRACT

A bidet according to an embodiment of the present invention includes: a bidet body to which a toilet seat having an opening is hingedly coupled; and a nozzle assembly disposed in the bidet body. The nozzle assembly includes: a nozzle body part forming an outer appearance thereof; and a sitz bath discharging port for spraying water and forming a water-current, the sitz bath water discharging port being disposed in the nozzle body part.

### TECHNICAL FIELD

The present disclosure relates to a bidet comprising a nozzle assembly, and more specifically, to a nozzle assembly having a sitz bath discharging port forming a water current by spraying water in arc form.

### BACKGROUND ART

Generally, a sitz bath is provided to alleviate stress on the anus by enabling a user to sit in water no to the anus after treatments and surgeries for conditions such as hemorrhoids or the like.

Thus, a user is often required to fill a sitz bath while having mobility difficulties, and for user convenience, various types of sitz bath devices have been introduced.

Further, such sitz baths are mainly used in the toilet due to their properties. In view of efficient use of space, a technology of adding a sitz bath function to a bidet has been shown. Here, the bidet is provided as a device that is installed on a toilet bowl to clean a user after using the toilet.

When the sitz bath function is added to the bidet in such a manner, the effect of a sitz bath may commonly be obtained by spraying water through a nozzle of the bidet.

However, a linear water current discharged from the nozzle may strain the anus due to having strong water pressure, thereby increasing the internal pressure of the anus in the short term, thus affecting the health of the anus.

Moreover, when a linear water current suddenly comes into contact with the anus when a sitz bath is started, the anus may be rapidly strained, and such a problem may become most acute at the point of time at which the sitz bath has been started.

In addition to the problem, as illustrated in FIG. 6, a common nozzle 1 of a bidet may spray water while being inclined forwardly from below the rear (C) of a user, thus causing secondary conditions, such as urinary tract infections, in the case of female users.

### DISCLOSURE

### Technical Problem

An aspect of the present disclosure may provide a bidet, which has a sitz bath discharging part forming a water current by spraying water in arc form, and which enables the water current to come into contact with a part of a user in the vicinity of the highest point of the water current, thus minimizing a stimulus to the user's anus when making a sitz bath, and reducing the internal pressure of the anus.

### Technical Solution

According to an aspect of the present disclosure, a bidet may include a bidet body to which a toilet seat having an opening may be hingedly coupled; and a nozzle assembly disposed in the bidet body. The nozzle assembly may include: a nozzle body part forming an outer appearance of the nozzle assembly; and a sitz bath discharging port for spraying water in arc form to form a water current, the sitz bath water discharging port being disposed in the nozzle body part.

According to an aspect of the present disclosure, a highest point of the water current may be formed inside the opening in a horizontal direction of the toilet seat.

According to an aspect of the present disclosure, the highest point of the water current may be formed to range from below 25 mm to above 25 mm, with respect to an upper surface of the toilet seat, in a vertical direction of the toilet seat.

According to an aspect of the present disclosure, the toilet seat may be positioned above a point at which the water current arcs downwardly after the highest point of the water current.

According to an aspect of the present disclosure, the water current and the toilet seat may not be in contact with each other.

According to an aspect of the present disclosure, the sitz bath discharging port may be provided as a plurality of sitz bath discharging ports spaced apart from each other.

According to an aspect of the present disclosure, the plurality of sitz bath discharging ports may form a plurality of water currents, and highest points of the plurality of water currents may be the same.

According to an aspect of the present disclosure, the plurality of sitz bath discharging ports may form the plurality of water currents, and the highest points of the plurality of water currents may be formed to range from below 25 mm to above 25 mm, with respect to an upper surface of the toilet seat, in a vertical direction, of the toilet seat.

### Advantageous Effects

According to an aspect of the present disclosure, a bidet may include a sitz bath discharging port for forming a water current by spraying water in arc form, and the water current may come into contact with a part of a user in the vicinity of the highest point of the water current, thus minimizing stimulus and stress to the user's anus when making a sitz bath to reduce internal pressure on the anus.

### DESCRIPTION OF DRAWINGS

FIG. 1 is an exploded perspective view of a bidet according an exemplary embodiment in the present disclosure;

FIG. 2 is a schematic perspective view of a nozzle assembly according to an exemplary embodiment in the present disclosure;

FIG. 3 is a schematic side view illustrating a positional relationship between a water current and a toilet seat according to an exemplary embodiment in the present disclosure;

FIGS. 4A and 4B are schematic perspective views of a nozzle assembly according to other exemplary embodiments in the present disclosure;

FIGS. 5A and 5B are schematic perspective side views illustrating the positional relationship between the water current and the toilet seat according to other exemplary embodiments in the present disclosure;

FIG. 6 is a schematic side view of a spray direction of a general bidet nozzle in the related art; and

FIG. 7 is a table of clinical test data of a bidet according to an exemplary embodiment in the present disclosure.

### BEST MODE FOR INVENTION

The terminology used herein describes particular embodiments only, and the present inventive concept is not limited thereby. As used herein, the singular forms “a,” “an,” and “the” are intended to include the plural forms as well, unless the context clearly indicates otherwise. It will be further understood that the terms “comprises,” and/or “comprising” when used in this specification, specify the presence of stated features, integers, steps, operations, members, elements, and/or groups thereof, but do not preclude the presence or addition of one or more other features, integers, steps, operations, members, elements, and/or groups thereof. The contents of the present inventive concept described below may have a variety of configurations and propose only a required configuration herein, but are not limited thereto.

Hereinafter, exemplary embodiments of the present disclosure will be described in detail with reference to the accompanying drawings. The disclosure may, however, be exemplified in many different forms and should not be construed as being limited to the specific emboiments set forth herein, and those skilled in the art and understanding the present disclosure can easily accomplish retrogressive inventions or other embodiments included in the scope of the present disclosure by the addition, modification, and removal of components within the same scope, but those are construed as being included in the scope of the present disclosure. Like reference numerals will be used to designate like components having similar functions throughout the drawings within the scope of the present disclosure.

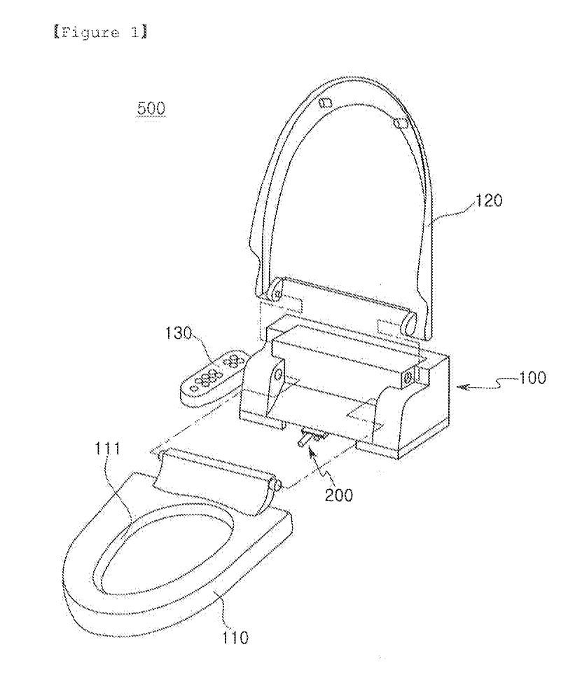

is an exploded perspective view of a bidet according to an exemplary embodiment in the present disclosure. With reference to FIG. 1, a bidet 500 according to an exemplary embodiment in the present disclosure may include a bidet body 100 and a nozzle assembly 200.

A toilet seat 110 having an opening 111 may be hingedly coupled to the bidet body 100, while a user may lower the toilet seat 110 onto a toilet bowl, or lift the toilet seat 110 above the toilet bowl according to need.

In other words, in a case in which the user tries to use the bidet 500, the user may use the bidet 500 in such a manner that the toilet seat 110 is put on the toilet bowl. In this case, the user's anus may be exposed toward a back of the bidet 500 including the nozzle assembly 200 through the opening 111 formed in the toilet seat 110.

In addition, a cover 120 may be hingedly coupled to the bidet body 100 to be able to revolve, and the toilet bowl may be opened or closed by allowing the cover 120 to revolve. The cover 120 may prevent a foreign substance from entering the toiler bowl, and may prevent an odor generated in, the toilet bowl from spreading out of the toilet bowl.

In addition, a control panel 130 may be provided on a side of the bidet body 100 to control an entirety of driving of the bidet 500, while in the control panel 130, a plurality of buttons may be provided for the user to select a predetermined function.

In the meantime, the nozzle assembly 200 may be provided on the bidet body 100, and hereinafter, a detailed description of the nozzle assembly 200 will be provided.

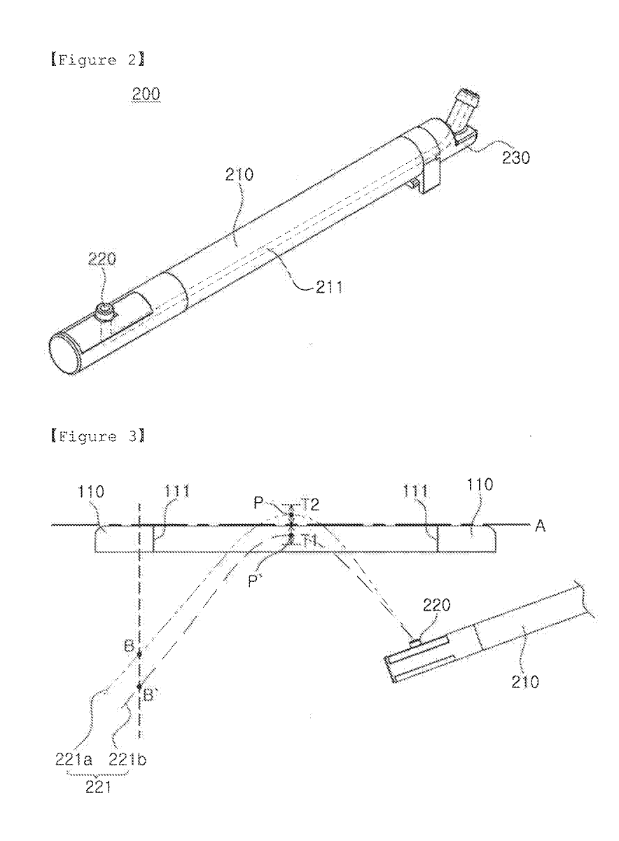

FIG. 2 is a schematic perspective view of a nozzle assembly 200 according to an exemplary embodiment, and FIG. 3 is a schematic side view illustrating a positional relationship between a water current and a toilet seat according to an exemplary embodiment.

With reference to FIGS. 2 and 3, the nozzle assembly 200 according to an exemplary embodiment may include a nozzle body part 210, a discharging port 220, and a connector 230.

The nozzle body part 210 may form an entirety of an outer appearance of the nozzle assembly 200, and may have the form of a cylinder. However, a person skilled in the art may propose not a cylinder form, but various forms such as a polygonal column, and the like, according to design necessity, which are also included within the scope of the technical concept of the present invention.

In addition, the discharging port 220 for spraying water may be provided on one end of the nozzle body part 210. In other words, when a user executes a sitz bath function of the bidet 500, the discharging port 220 may spray water to the user's anus. The discharging port 220 may be connected to the connector 230 by an internal channel 211 formed inside the nozzle body part 210.

The connector 230 may be provided on the other end, in which the discharging port 220 of the nozzle body part 210 is not provided, to be connected to a water source through a connecting hose (not shown). In other words, water supplied from the water source may flow through the connector 230 and the internal channel 211 into the discharging port 220 to be finally sprayed from the discharging on 220.

On the other hand, the discharging port 220 may spray water in arc form to form a water current 221, and the water current 221 may have various paths 221a and 221b according to a type of an orifice formed in the discharging port 220 or to a spray pressure (see FIG. 3).

At this time, highest points P and P′ of the water current 221 may be located inside an opening 111 of a toilet seat 110 in a horizontal direction thereof. Thus, when the opening 111 is viewed from above in a vertical direction of the toilet seat 110, a highest point of the water current 221 may be observed.

Here, when terms with respect to directions are defined, a horizontal direction denotes a direction parallel to an upper 115 surface A of the toilet seat 110 based on FIG. 3, and a vertical direction denotes a direction perpendicular to the upper surface A of the toilet seat 110 based on FIG. 3.

In addition, the highest points P and P′ of the water current 221 may be formed to range from below 25 mm T1 to above 22 mm T2 in a vertical direction of the toilet seat 110, with respect to the upper surface A of the toilet seat 110.

In other words, water discharged from the discharging port 220 of the bidet 500 according to an exemplary embodiment may form the water current 221 having an arc shape, and may be in contact with the user's anus around the highest points P and P′ of the water current 221.

Thus, a force directed upwardly in a vertical direction of the water current 221 may be virtually eliminated to significantly reduce stimulation and stress to the user'a anus and to reduce an internal pressure on the anus.

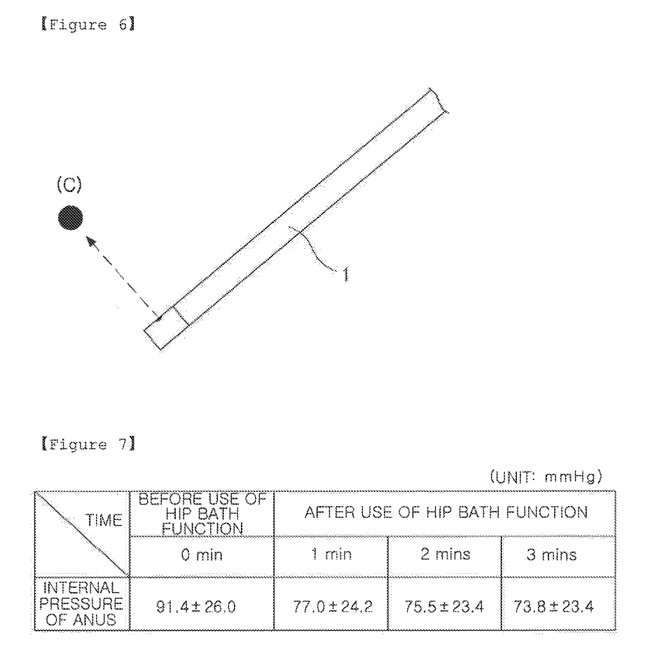

In addition, when the highest points P and P of the water current 221 are formed within the above range, that is, from below 25 mm T1 to above 25 mm T2 in a vertical direction of the toilet seat 110, with respect to the upper surface A of the toilet seat 110, reducing an internal pressure on the user s anus may be confirmed through a clinical test result (see FIG. 7).

In addition, the toilet seat 110 may be positioned in an upper portion of points B and B′ in which the water current 221 arcs downwardly through the highest points P and P′. In other words, the water current 221 passing through the highest points P and P′ may arc downwardly of the toilet seat 110 in the vertical direction of the toilet seat 110. Thus, the water current 221 having an arc shape, sprayed from the discharging port 220, may not be in contact with the toilet seat 110, and may arc inwardly of a toilet bowl.

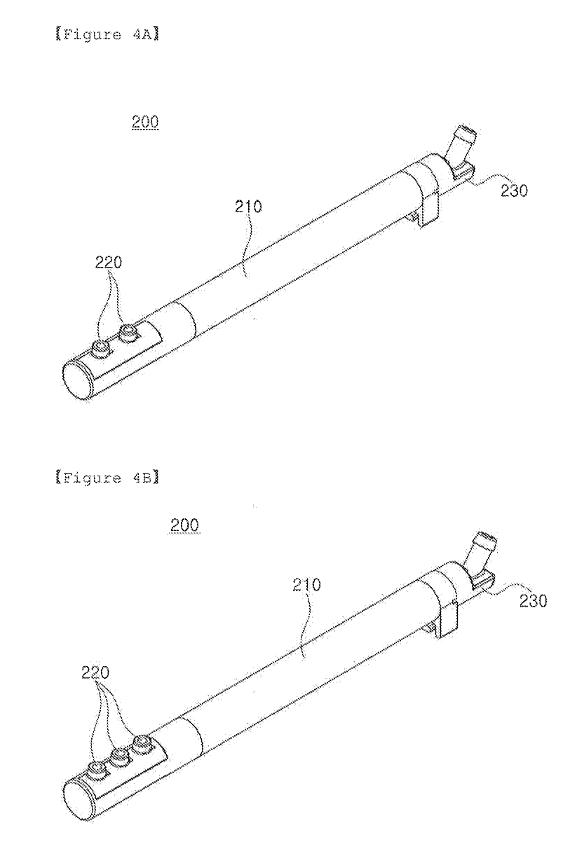

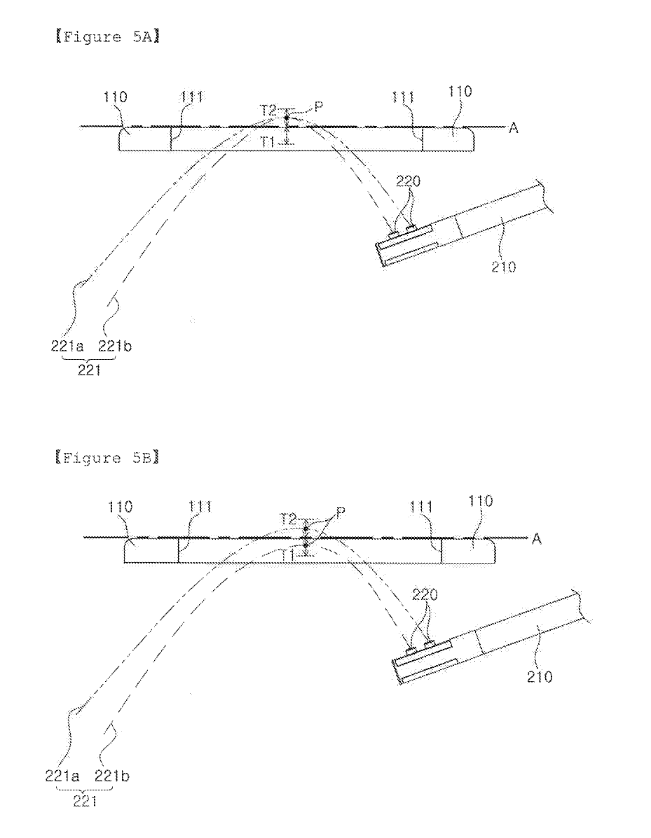

FIGS. 4A and 4B are schematic perspective views of a nozzle assembly 200 according to other exemplary embodiments, and FIGS. 5A and 5B are schematic side views illustrating a positional relationship between a water current 221 and a toilet seat 110 according to other exemplary embodiments.

With reference to FIGS. 4 and 5, the nozzle assembly 200 according to other exemplary embodiments may have the same configurations as those of the nozzle assembly 200 illustrated in FIGS. 1 to 3, and only a configuration of a discharging port 220 of the nozzle assembly 200 according to other exemplary embodiments may be different.

Thus, detailed descriptions of the same configurations are omitted and substituted with the descriptions described above.

With reference to FIGS. 4 and 5, in the nozzle assembly 200 according to other exemplary embodiments, the discharging port 220 may be provided as a plurality of discharging ports 220 spaced apart from each other.

Meanwhile, on the drawings, the discharging port 220 is illustrated as being provided, as two or three discharging ports 220 arranged in a line, but is not limited thereto. The number and arrangement of the discharging ports 220 may be changed in various ways.

The plurality of the discharging ports 220 may spray water in arc form to form, a plurality of water currents 221 and 222.

At this time, highest points P of a plurality of water currents 221 and 222 may be the same (see FIG. 5A). Merely, the highest points P of the plurality of at currents 221 and 222 may also be formed to be spaced apart from each other (see FIG. 5B). In either case, the highest points P of the water currents 221 and 222 may be formed to range from below 25 mm T1 to above 25 mm T2, with respect to an upper surface of a toilet seat 110.

While exemplary embodiments have been shown and described above, it will be apparent to those skilled in the art that modifications and variations could be made without departing from the scope of the present invention as defined by the appended claims.

1. A bidet comprising:
a bidet body to which a toilet seat having an opening is hingedly coupled; and
a nozzle assembly disposed in the bidet body,
wherein the nozzle assembly comprises a nozzle body part forming an outer appearance of the nozzle assembly, and a sitz bath discharging port for spraying water in arc form to form a water current, the sitz bath water discharging port being disposed in the nozzle body part.

2. The bidet of claim 1, wherein a highest point of the water current is formed inside the opening in a horizontal direction of the toilet seat.

3. The bidet of claim 1, wherein a highest point of the water current is formed to range from below 25 mm to above 25 mm, with respect to an upper surface of the toilet seat, in a vertical direction of the toilet seat.

4. The bidet of claim 1, wherein the toilet seat is positioned above a point at which the water current arcs downwardly through a highest point of the water current.

5. The bidet of claim 1, wherein the water current and the toilet seat are not in contact with each other.

6. The bidet of claim 1, wherein the sitz bath discharging port is provided as a plurality of sitz bath discharging ports spaced apart from each other.

7. The bidet of claim 6, wherein the plurality of sitz bath discharging ports form a plurality of water currents, and highest points of the plurality of water currents are the same.

8. The bidet of claim 6, wherein the plurality of sitz bath discharging ports form a plurality of water currents, and highest points of the plurality of water currents are formed. to range from below 25 mm to above 25 mm, with respect Loan upper surface of the toilet seat, in a vertical direction of the toilet seat.
